(19) United States
(12) Patent Application Publication
(10) Pub. No.: US 2021/0342470 A1
(43) Pub. Date: Nov. 4, 2021

(54) SECURE ATTRIBUTE VERIFICATION

(71) Applicant: LENOVO (Singapore) PTE. LTD., New Tech Park (SG)

(72) Inventors: Igor Stolbikov, Apex, NC (US); Jixin Feng, Cary, NC (US); Scott W. Li, Cary, NC (US)

(21) Appl. No.: 16/863,850

(22) Filed: Apr. 30, 2020

(51) Int. Cl. G06F 21/62; H04L 29/06; H04L 9/06

(52) U.S. Cl. CPC G06F 21/6245; H04L 2209/38; H04L 9/0643; H04L 63/123

(57) ABSTRACT

For secure attribute verification, a processor generates a plurality of hashes of a seed and a previous public group index. The processor further iteratively generates a public group index for each hash. The processor generates a one-time user identifier expressed as a hash chain of identifiers each based on one of the public group indexes. The processor verifies user attributes from the one-time user identifier.

### FIELD

The subject matter disclosed herein relates to attribute verification.

### BACKGROUND

User attributes are often verified during transactions.

### BRIEF SUMMARY

An apparatus for secure attribute verification is disclosed. The apparatus includes a processor and a memory that stores code executable by the processor. The processor generates a plurality of hashes of a seed and a previous public group index. The processor further iteratively generates a public group index for each hash. The processor generates a one-time user identifier expressed as a hash chain of identifiers each based on one of the public group indexes. The processor verifies user attributes from the one-time user identifier. A method and program product also perform the functions of the apparatus.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of an attribute verification system;

FIG. 2 is a schematic block diagram illustrating one embodiment of verification data;

FIG. 3A is a schematic block diagram illustrating one embodiment of one-time user identifiers;

FIG. 3B is a schematic block diagram illustrating one alternate embodiment of one-time user identifiers;

FIG. 4 is a schematic block diagram illustrating one embodiment of a computer; and

FIG. 5 is a schematic flow chart diagram illustrating one embodiment of an attribute verification method.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise. The term “and/or” indicates embodiments of one or more of the listed elements, with “A and/or B” indicating embodiments of element A alone, element B alone, or elements A and B taken together.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

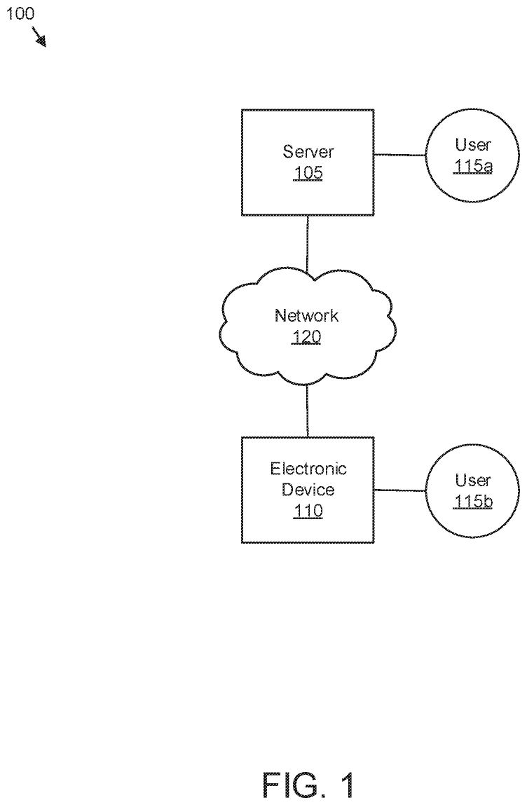

FIG. 1 is a schematic block diagram illustrating one embodiment of an attribute verification system 100. The attribute verification system 100 verifies attributes of a user 115b to a server 105 and/or other users 115a. The user 115b may communicate with the server 105 and/or the other user 115a via an electronic device 110. The electronic device may be a mobile phone, a computer, a tablet computer, and the like.

The electronic device 110 communicates with the server 105 and/or other user 115a via a network 120. The network 120 may include a mobile telephone network, the Internet, a WiFi network, a wide area network, a local area network, or combinations thereof.

The server 105 and/or other user 115a may request that the user 115b provide one or more user attributes with which to verify the user's identify. The user attributes may include a name, an address, an identification number such as a social security number, an email address, a phone number, an employer, and the like. Unfortunately, communicating the user attributes to the server 105 may expose those user attributes to interception. For example, the user attributes may be intercepted in the vicinity of the electronic device 105 and/or during communication over the network 120. As a result, providing the user attributes puts those user attributes at risk of misappropriation.

The embodiments generate a one-time user identifier of identifiers that may be communicated from the user 115b via the electronic device 110 and the network 120 to the server 105 and/or other user 115a. The one-time user identifier is used by the server 105 and/or other user 115a in place of providing the user attributes. The one-time user identifier protects the user attributes, even if the one-time user identifier is intercepted. As a result, the user attributes are efficiently protected by the electronic device 110 and/or the server 105.

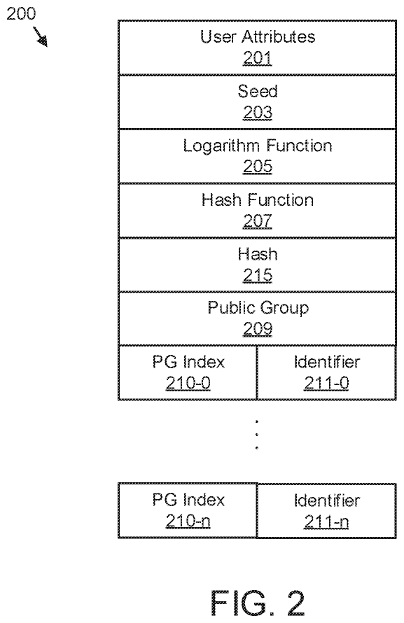

FIG. 2 is a schematic block diagram illustrating one embodiment of verification data 200. The verification data 200 may be used to generate the one-time user identifier and to verify the user attributes 201. The verification data 200 maybe organized as a data structure in a memory. In the depicted embodiment, the verification data 200 includes the user attributes 201, a seed 203, a logarithm function 205, a hash function 207, a public group 209, one or more public group indexes 210, and one or more corresponding identifiers 211.

The user attributes 201 may comprise a social security number, an email address, a phone number, an employer, and the like. The user attributes 201 are known to both the server 105 and the user 115b.

The seed 203 may be an input to a hash 215. The seed 203 may be a hash of one or more user attributes 201. For example, the seed 203 may be the user's social security number or a hash of the user's social security number.

The hash function 207 generates a hash 215 of the seed 203 and/or a previous public group index 210. In one embodiment, the hash function 207 generates the hash 215 as a unique, deterministic value from the seed 203 and/or previous public group index 210. In one embodiment, an initial hash 215 is generated from only the seed 203. The hash function 207 may be a cryptographic hash function.

The public group 209 may include a large corpus of words. Each of the words may be an identifier 211. In one embodiment, the public group 209 is a dictionary. The public group 209 may be of a large order q. In one embodiment, q is greater than 50,000, where q is the number of identifiers 211 in the public group 209. Each public group index 210 may select a unique identifier 211 such as a word from the public group 209.

The logarithm function 205 may be used to calculate the public group index 210. In one embodiment, each public group index 210 is calculated as a logarithm function 205 over the public group 209 of the hash 215. The logarithm function 205 may generate a unique public group index 210 from a given hash 215.

Each identifier 211 is generated by using the public group index 210 to index the public group 209 to retrieve a corresponding identifier 211. Thus the verification data 200 may be used to generate one or more identifiers 211 from a seed 203 and/or a previous public group index 210.

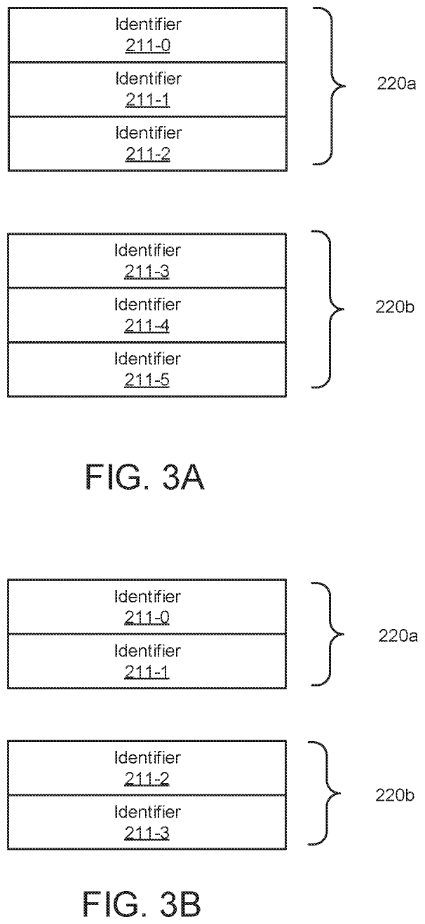

FIG. 3A is a schematic block diagram illustrating one embodiment of one-time user identifiers 220. In the depicted embodiment, the one-time user identifiers 220 each comprise three identifiers 211. A first one-time user identifier 220a comprises a user identifiers 211-0-2. A second one-time user identifier 220b comprises user identifiers 211-3-5. In one embodiment, a given public group index 210 is the previous public group index 210 for a subsequent verification of the user attributes 201

FIG. 3B is a schematic block diagram illustrating one alternate embodiment of one-time user identifiers 220. In the depicted embodiment, the one-time user identifiers 220 each comprise two identifiers 211. A first one-time user identifier 220a comprises a user identifiers 211-0-1. A second one-time user identifier 220b comprises user identifiers 211-2-3. In addition, the one-time user identifier 220 may comprise in the range of 2-4 identifiers 211.

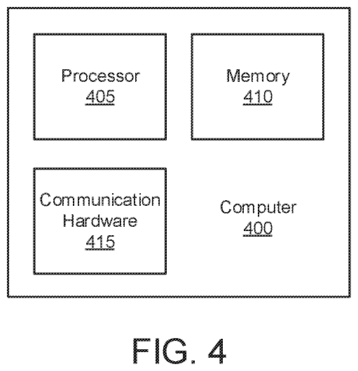

FIG. 4 is a schematic block diagram illustrating one embodiment of a computer 400. The computer 400 may be embodied in the server 105 and/or the electronic device 110. In the depicted embodiment, the computer 400 includes a processor 405, a memory 410, and communication hardware 415. The memory 410 may include a semiconductor storage device, a hard disk drive, an optical storage device, or combinations thereof. The memory 410 may store code. The processor 405 may execute the code. The communication hardware 415 may communicate with other devices such as the network 120.

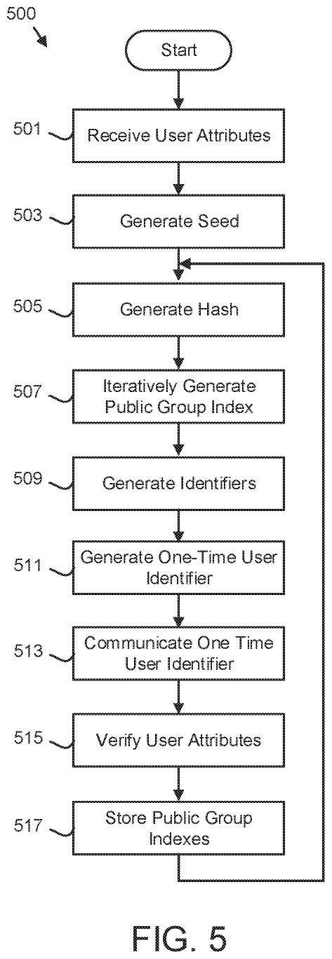

FIG. 5 is a schematic flow chart diagram illustrating one embodiment of an attribute verification method 500. The method 500 may generate the one-time user identifier 220 and verify user attributes 201 from the one-time user identifier 220. The method 500 may be performed by the computer 400 and/or the processor 405 of the electronic device 110 and the server 105. Thus, both the electronic device 110 and the server 105 generate the one-time user identifier 220.

The method 500 starts, and in one embodiment, the processor 405 receives 501 the user attributes 201. In a certain embodiment, the user 115b enters the user attributes 201 on the electronic device 110. The electronic device 210 may securely communicate the user attributes 201 to the server 105. As a result, both the server 105 and the user 115b are in possession of the same user attributes 201.

The processor 405 further generates 503 the seed 203. The seed 203 may be a user attribute 201. For example, the seed 203 may be a Social Security number. The seed 203 may be generated as a hash 215 of one or more user attributes 201. For example, the seed 203 may be a hash 215 generated by the hash function 207 of a Social Security number user attribute 201.

The processor 405 further generates 505 a plurality of hashes 215 of the seed 203 and/or previous public group indexes 210. An initial hash 215 may be generated from only the seed 203. In one embodiment, the hash H 215 is generated 505 using Equation 1, where HF is the hash function 207, S is the seed 203, and y₀ is a previous public group index 210.

H=HF(s+y₀) Equation 1

The processor 405 may generate 505 a hash 215 for each identifier 211 of the one-time user identifier 220. For example, if the one-time user identifiers 220 includes three identifiers 211, the processor 405 generates 505 three hashes 215, HF(s), HF(s+y₀), HF(s+y₁). In one embodiment, a given public group index 210 is the previous public group index 210 for a subsequent verification of the user attributes 201. For example, the public group index y₁ 210 may have been calculated for a previous one-time user identifier 220 and stored in the verification data 200.

The processor 405 further iteratively generates 507 a public group index 210 for each hash 215. Each public group index 210 may be calculated as a deterministic function of the hash 215. In one embodiment, each public group index 210 is calculated as a hard discrete logarithm function 205 over the public group 209 over the hash 215. In addition, each public group index 210 may be calculated as a hard logarithm function 205 over the public group 209 of the hash 215. In a certain embodiment, a public group index PGI 210 is calculated using Equation 2

PGI=g^{H} mod q Equation 2

The processor 405 may generate 509 each identifier 211 by using the public group index 210 to index the public group 209 to retrieve the corresponding identifier 211. For example, the public group index 210 may point to a first identifier 211 in the public group 209. In one embodiment, the identifiers I 211 are generated 509 using Equation 3, where PG is the public group 209. Each identifier 211 is based on one of the public group indexes PGI 210.

I=PG(PGI) Equation 3

The processor 405 generates 511 the one-time user identifier 220 expresses a hash chain of identifiers 211. For example, the one-time user identifier UI 220 may be generated 511 as shown in Equation 4, where I₀=PG(g^{H0} mod g), I₁=PG(g^{H1} mod g), I₂=PG(g^{H2} mod q).

UI=I₀,I₁,I₂ Equation 4

The processor 405 may communicate 513 the one-time user identifier 220 from the electronic device 105 to the server 105 and/or the other user 115a. Both the electronic device 110 and the server 105 generate the same one-time user identifier 220. The server 105 and/or the other user 115a may verify 515 the user attribute 201 from the one-time user identifier 220. The user attribute 201 may be verified 515 by comparing the one-time user identifier 220 from the electronic device 105 with the corresponding one-time user identifier 220 generated by the server 105. If the one-time user identifiers 220 match, the user attributes 201 are verified.

The processor 405 further stores 517 each public group index 210 in the verification data 200. As a result, a given public group index 210 is available for use as the previous public group index 210 for a subsequent verification of the user attributes 201.

The embodiments generate the one-time user identifier 220 expressed as a hash chain of identifiers 211 at both the server 105 and the electronic device 110. The server 105 and electronic device 110 must each have knowledge of the user attributes 201 and previous public group indexes 210 in order to generate the one-time user identifier 220. As a result, the user 115a may securely verify the user attributes 201 by communicating the one-time user identifier 220, improving the efficiency of the computers 400 and/or processors 405.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a processor;
a memory storing code executable by the processor to:
generate a plurality of the hashes of a seed and a previous public group index;
iteratively generate a public group index for each hash;
generate a one-time user identifier expressed as a hash chain of identifiers each based on one of the public group indexes; and
verify user attributes from the one-time user identifier.

2. The apparatus of claim 1, wherein an initial hash is generated from only the seed.

3. The apparatus of claim 2, wherein the code is further executable by the processor to generate the seed as a hash of user attributes.

4. The apparatus of claim 1, wherein the code is further executable by the processor to generate the identifier by using the public group index to index a public group to retrieve the corresponding identifier.

5. The apparatus of claim 4, wherein each public group index calculated as a deterministic function of the hash.

6. The apparatus of claim 4, wherein each public group index calculated as hard discreet logarithm function over the public group of large order q over the hash.

7. The apparatus of claim 4, wherein each public group index calculated as a hard logarithm function over the public group of large order q of the hash, wherein q is a number of identifiers in the public group.

8. The apparatus of claim 1, where a given public group index is the previous public group index for a subsequent verification of the user attributes.

9. The apparatus of claim 1, wherein the one-time user identifier comprises in the range of 2-4 identifiers.

10. A method comprising:
generating, by use of a processor, a plurality of the hashes of a seed and a previous public group index;
iteratively generating a public group index for each hash;
generating a one-time user identifier expressed as a hash chain of identifiers each based on one of the public group indexes; and
verifying user attributes from the one-time user identifier.

11. The method of claim 10, wherein an initial hash is generated from only the seed.

12. The method of claim 11, wherein the method further comprises generating the seed as a hash of user attributes.

13. The method of claim 10, the method further comprising generating the identifier by using the public group index to index a public group to retrieve the corresponding identifier.

14. The method of claim 13, wherein each public group index calculated as a deterministic function of the hash.

15. The method of claim 13, wherein each public group index calculated as hard discreet logarithm function over the public group of large order q over the hash.

16. The method of claim 13, wherein each public group index calculated as a hard logarithm function over the public group of large order q of the hash, wherein q is a number of identifiers in the public group.

17. The method of claim 10, where a given public group index is the previous public group index for a subsequent verification of the user attributes.

18. The method of claim 10, wherein the one-time user identifier comprises in the range of 2-4 identifiers.

19. A program product comprising a computer readable storage medium that stores code executable by a processor, the executable code comprising code to:
generate a plurality of the hashes of a seed and a previous public group index;
iteratively generate a public group index for each hash;
generate a one-time user identifier expressed as a hash chain of identifiers each based on one of the public group indexes; and
verify user attributes from the one-time user identifier.

20. The program product of claim 19, wherein the code is further executable by the processor to generate the identifier by using the public group index to index a public group to retrieve the corresponding identifier.
